(19) United States
(12) Patent Application Publication
(10) Pub. No.: US 2025/0012238 A1
(43) Pub. Date: Jan. 9, 2025

(54) Six bolt carburetor float bowl housing securement

(71) Applicant: Weaver Intellectual Property, LLC, Jupiter, FL (US)

(72) Inventors: Ronald J. Weaver, Jupiter, FL (US); Chad Szwarnowicz, Jupiter, FL (US)

(21) Appl. No.: 18/763,315

(22) Filed: Jul. 3, 2024

Related U.S. Application Data
(60) Provisional application No. 63/512,300, filed on Jul. 7, 2023.

(51) Int. Cl. F02M 5/12; F16B 5/02

(52) U.S. Cl. CPC F02M 5/12; F16B 5/02

(57) ABSTRACT

A carburetor comprising a throttle body having six apertures positioned at a distance not to exceed 72 mm from an adjoining aperture. The float bowl housing has reciprocal threaded receptacles for receipt of a fastening bolt having a washer integrated with a hex head and an anti-vibration locking washer secured in each reciprocal. Wherein the gasket positioned between the throttle body and the float bowl housing is evenly compressed and has a predetermined distance between fasteners. The carburetor design solves a long sought need to assist carburetors in reaching or exceeding the recommended engine TBO by addressing the gasket failure that commonly occurs between the float bowl housing and throttle body assembly.

### PRIORITY CLAIM

In accordance with 37 C.F.R. § 1.76, a claim of priority is included in an Application Data Sheet filed concurrently herewith. Accordingly, the present invention claims priority to U.S. Provisional Patent Application No. 63/512,300, entitled “Six Bolt Carburetor Float Bowl Housing Securement”, filed Jul. 7, 2023. The above referenced application is incorporated herein by reference.

### FIELD OF THE INVENTION

This invention is directed to the field of general aviation carburetors; and, in particular, to an improved carburetor float bowl housing securement.

### BACKGROUND OF THE INVENTION

Most general aviation aircraft employ internal combustion engines using a carbureted fuel system. Carburetors provide a calculated air-fuel admixture for detonation to supplement the engine's combustion stroke. Ideally, the carburetor provides an air-fuel admixture of about 15-to-1 stoichiometric ratio, which ideally would cause the air-fuel admixture to be completely used in the combustion stroke.

A carburetor should remain maintenance free during the life of the engine. In aviation, the engine life averages about 2000 hours of operation between overhauls (TBO), or 10 years time. During the overhaul process, the carburetor would also be overhauled. However, carburetors are notorious for leaking long before the TBO. A major cause of leaking is gasket failure caused by infrequent use of the engine.

In particular, a gasket positioned between the float bowl housing and throttle body assembly is notorious for premature failure. A conventional carburetor employs a float bowl housing to provide a constant level of fuel to a discharge nozzle placed along the lowest pressure portion of a venturi. The float bowl housing includes a needle valve to keep the fuel level constant in the chamber. Storage, or the like infrequent use, causes the gasket to dry out and lose their sealing qualities. Once the gasket fails, fuel can escape the float bowl housing, which can lead to a fire hazard. If the airplane is parked outside, the leaking fuel may not be detected until an annual inspection is performed. In any event, a fuel leak must be addressed quickly.

Proper repair of the carburetor requires removal from the engine, resulting in down time and inconvenience to the airplane owner. Further, the cost of having a carburetor removed and repaired is costly, but a critical repair that cannot be postponed. When a float bowl housing gasket failure occurs before the required TBO, the owner must pay for two separate maintenance events.

Various attempts have been made to maintain a proper seal of the float bowl housing gasket. The use of a gasket sealing compound is known, but may lead to other problems, such as clogged needle jets should the sealing compound enter the fuel system.

What is lacking in the industry is a teaching of a carburetor improvement to address the gasket failure that commonly occurs between the float bowl housing and the throttle body assembly.

### SUMMARY OF THE INVENTION

Disclosed is an improvement in carburetor design through the placement of fasteners that secure a float bowl housing to a throttle body assembly. Conventional carburetors use four fasteners for securing the float bowl housing to the throttle body. The instant invention employs six strategically positioned fasteners to properly compress a gasket. In the preferred embodiment, carburetors are adapted to include a six bolt attachment, wherein spacing between the bolt attachments do not exceed 72 mm spacing therebetween. Fastener bolts having a washer integrated to a large hex head are used in combination with anti-vibration locking washers for securement. The bolts are torqued to about 100 in-lbs for securing the throttle body to the float bowl housing.

An objective of the invention is to teach improvements in carburetor design to assist in reaching or exceeding the recommended engine TBO by addressing the gasket failure that commonly occurs between the float bowl housing and throttle body assembly.

Another objective of the invention is to form a throttle body and fuel bowl chamber for receipt of six fasteners, each fastener spaced apart from an adjoining fastener by a distance not to exceed 72 mm.

Still another objective of the invention is to employ a fastener constructed from a large hex head bolt with a threaded shank depending therefrom; the hex head including a washer formed integral thereto for uniform load distribution, the bolt securable to the assembly in combination with an anti-vibration locking washer to about 100 in-lbs.

Yet still another objective of the invention is to have a bolt pattern, wherein spacing between first and second apertures at the front of the carburetor is about 71.44 mm, spacing between second and third apertures at the front right of the carburetor is about 53.74 mm, spacing between third and fourth apertures at the rear right of the carburetor is about 53.77 mm, spacing between fourth and fifth apertures at the rear of the carburetor is about 33.32 mm, spacing between fifth and sixth apertures at the rear left of the carburetor is about 40.25 mm, and spacing between sixth and first apertures at the front left of the carburetor is about 62.40 mm.

Another objective of the invention is to provide gasket sealing to reach or exceed the recommended engine TBO by addressing the gasket failure that commonly occurs between the float bowl housing and throttle body assembly.

Other objectives and further advantages and benefits associated with this invention will be apparent to those skilled in the art from the description, examples, and claims which follow.

### BRIEF DESCRIPTION OF THE DRAWINGS

FIG. 1 is a right perspective view of the general aviation carburetor having a six bolt chamber.

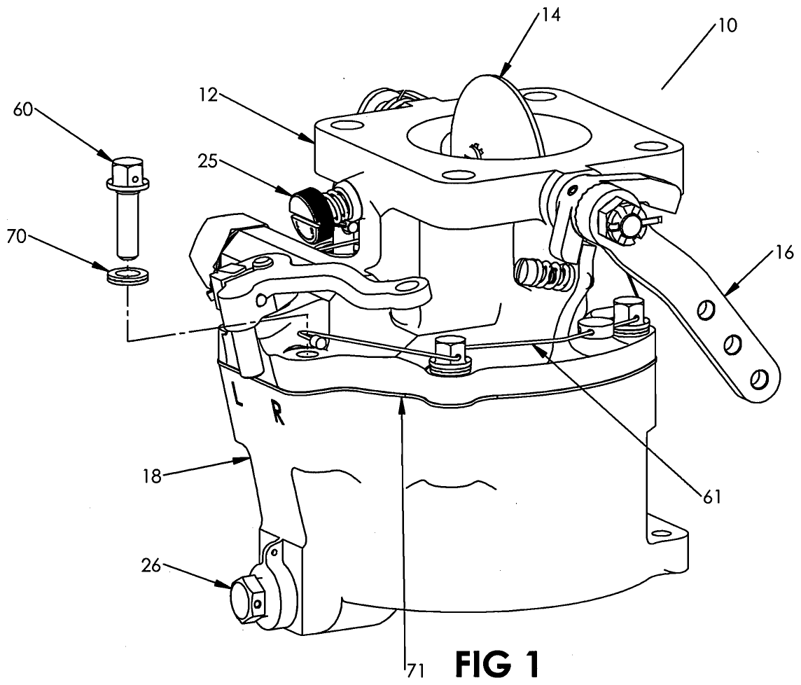

FIG. 2 is a left perspective view thereof of the front panel;

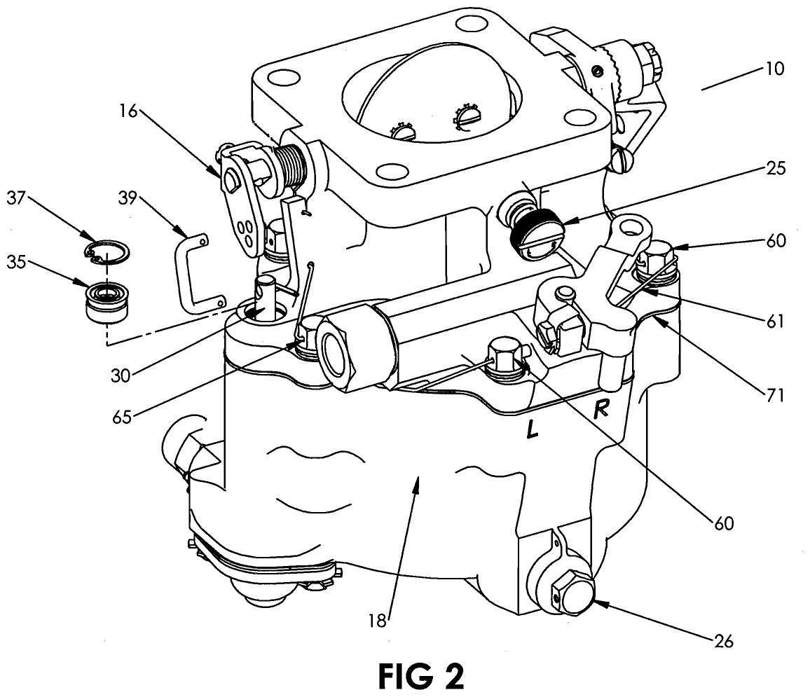

FIG. 3 is a top view thereof;

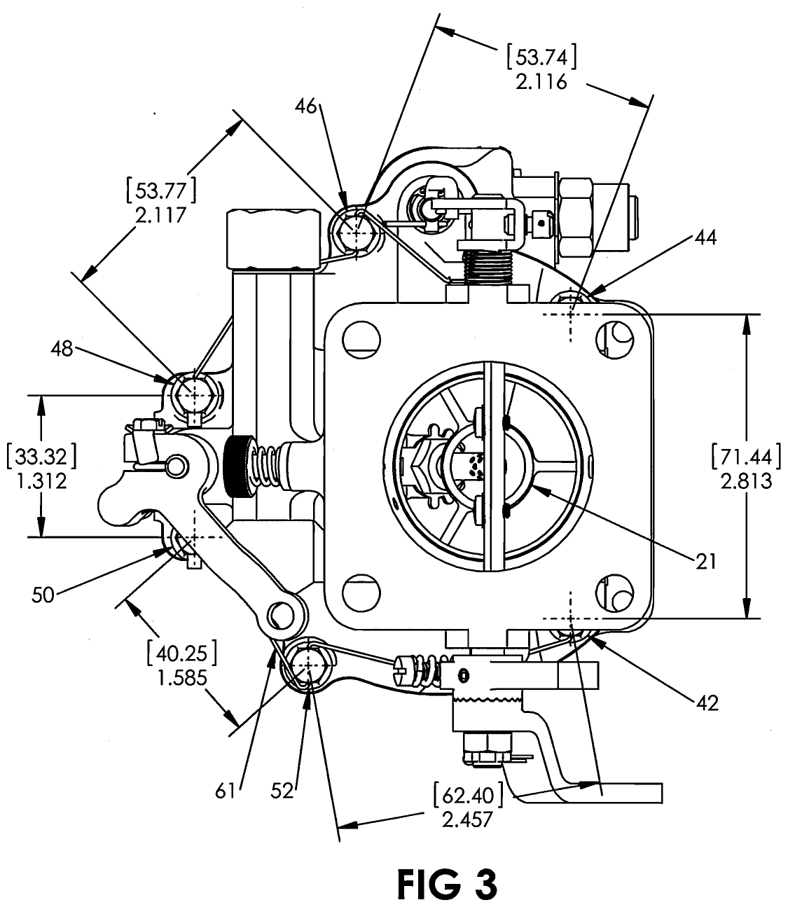

FIG. 4 is a right perspective view of the float bowl housing;

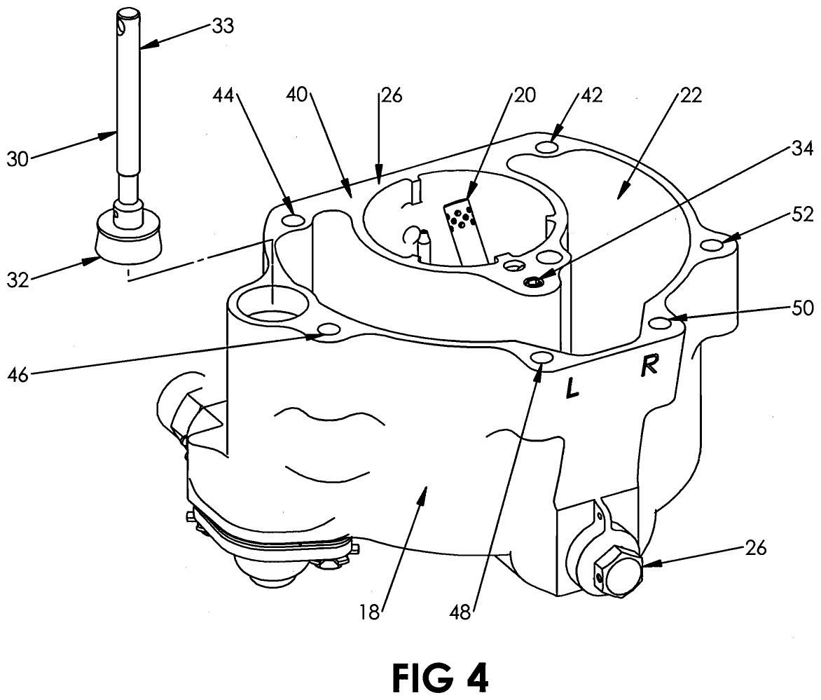

FIG. 5 is cross-sectional side view of a bowl fastener; and

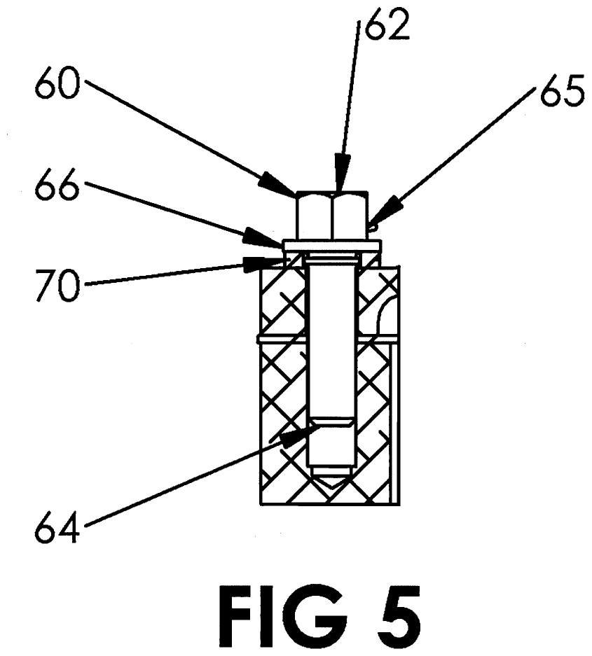

FIG. 6 is a cross-sectional side view of the bowl plunger.

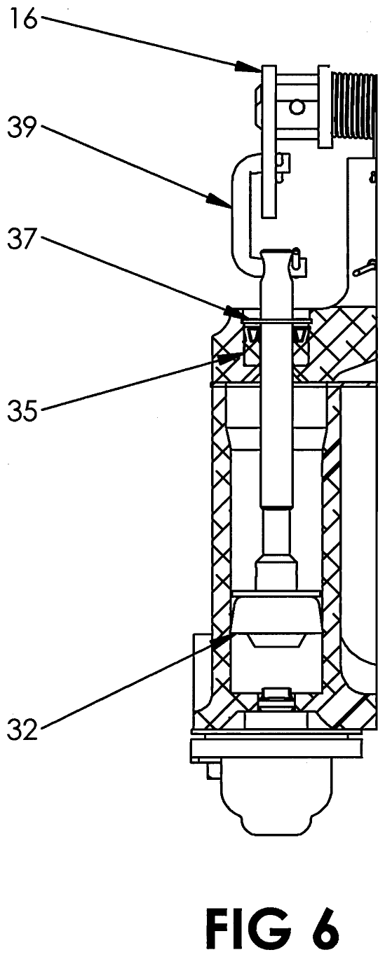

### DETAILED DESCRIPTION OF THE PREFERRED EMBODIMENT

A detailed embodiment of the instant invention is disclosed herein. Specific functional and structural details disclosed herein are not to be interpreted as limiting, but merely as a basis for the claims and as a representation basis for teaching one skilled in the art to variously employ the present invention in virtually any appropriately detailed structure.

Conventional carburetors of the type addressed herein employ a float bowl housing attached to a throttle body assembly by use of four bolts; the float bowl housing having an upper planar surface mating with a lower planar surface of the throttle body assembly. A gasket is placed between the mating surfaces, creating a seal between the bowl housing and the throttle body assembly. Over a period of time, the gasket is known to dry out and leak, requiring replacement for the proper operation of the carburetor, as well as the safety of passengers. One known repair is to use a gasket compound to assist in sealing; however, gasket compound can degrade over time and cause contamination of the fuel. Applicant's use of six bolts allows the pressure on the gasket to be uniform and maintains compressive force service between the float bowl housing and the throttle body assembly.

Referring to the Figures, depicted is a carburetor 10 having a throttle body assembly 12 with a throttle valve 14 and linkage 16. A float bowl housing 18 contains a chamber 22 for a float member, not shown. The chamber 22 provides a constant level of fuel to feed a discharge nozzle 20 placed along the lowest pressure portion of a venturi 21. The float bowl housing 18 typically includes a drain plug 26. An accelerator pump 30 is depicted having a polymer plunger cup 32 at the bottom of a shaft 33 with a spring energized seal 35, also constructed of a polymer, which is held in place with a snap retaining ring 37. A U-shaped connector 39 couples to the accelerator pump 30 and throttle body linkage 16. The venturi 21 causes air pressure to be dropped, in accordance with Bernoulli's principle, wherein fuel is introduced into induction air before entry into the cylinders for the combustion process. The carburetor's operation depends on the differential pressure caused by the venturi 21.

A main fuel discharge nozzle 20 is used so that the fuel can atomize and diffuse to the maximum extent possible, and an adjustable needle 25 provides for idling. Airflow through the venturi 21 is a result of the suction generated by the engine pistons as they cycle through the intake stroke. Fuel is ejected from the nozzle 20 in a fine spray that quickly vaporizes in the air for use in the combustion step. The idling system includes an idle tube 34 that draws fuel through a passageway between the float bowl housing and a point near the throttle valve. A manual mixture control restricts the flow of fuel to the fuel nozzle to allow compensation when operating at various altitudes. To control the airflow to the combustion chambers, the throttle valve is installed in the carburetor downstream from the venturi 21. The throttle valve linkage 16 is manually controlled by a cockpit mounted controller, not shown. Opening the throttle valve 14 allows the carburetor to flow more fuel to maintain the appropriate air-to-fuel ratio in the cylinders.

The float bowl housing 18 has an upper surface 40 for receipt of a gasket 71 to provide a seal with the adjoining throttle body housing 12; the float bowl housing 18 having a space between first 42 and second apertures 44 at the front of said carburetor of about 71.44 mm, spacing between the second 44 and third 46 apertures at the front right of said carburetor is about 53.74 mm, spacing between the third 46 and fourth 48 apertures at the rear right of the carburetor is about 53.77 mm, spacing between the fourth 48 and fifth 50 apertures at the rear of said carburetor is about 33.32 mm, spacing between the fifth 50 and sixth 52 apertures at the rear left of said carburetor is about 40.25 mm, and spacing between the sixth 52 and the first aperture 42 at the front left of said carburetor is about 62.40 mm. Bolts 60 are used to secure the housings 12, 18 together; the bolts being torqued to a specific load, wherein they are constructed and arranged to properly compress a gasket 71 placed between the throttle body 12 and float bowl housing 18, with spacing between the apertures not to exceed a span greater than 72 mm.

The fastener bolts 60 are formed from a large hex head 62 with a threaded shank 64 depending therefrom. The hex head 62 includes a washer 66 formed integral thereto, which is constructed and arranged to provide uniform load distribution. In the preferred embodiment, each fastener bolt 60 is a number 12 with 24 threads per inch and torqued to 100 in-lbs. Each said fastener bolt 60 is constructed of high strength steel and plated for corrosion resistance. An anti-vibration locking washer 70 is positioned between the fastener bolt washer 66 and the respective throttle body aperture. The bolts 60 are drilled, providing an aperture 65 receptive to a safety wire 61, wherein the second, third and fourth fastener bolts are safety wired together; and the fifth, sixth and first fastener bolts are safety wired together.

Steps for the improved carburetor comprise: forming a throttle body with six apertures positioned along a base, each aperture spaced apart from an adjoining aperture at a distance not to exceed 72 mm; modifying a float bowl housing to include six threaded receptacles placed in-line with said throttle body apertures; positioning a gasket between said throttle body and said float bowl housing; placing a fastener bolt through each said aperture for engaging each said threaded receptacle; and torquing each fastener bolt to about 100 in-lbs. for securing said throttle body to said float bowl housing wherein the gasket is evenly compressed.

It is noted that the carburetor 10 depicted in this disclosure is for illustration purposes only. There are numerous carburetor shapes, all of which use the conventional 4 bolt attachment for securing a throttle body to a float bowl housing. It will be understood by one skilled in the art that the adaptation of the disclosed six bolt attachment and spacing to other carburetors is deemed within the scope of this invention.

The term “about” means, in general, the stated value plus or minus 5%. The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A carburetor comprising:
a throttle body with six apertures positioned along a base, each aperture spaced apart from an adjoining aperture at a distance not to exceed 72 mm;
a float bowl housing to include six threaded receptacles placed in-line with said six throttle body apertures;
a gasket between said throttle body and said float bowl housing;
a fastener bolt through each said aperture for engaging each said threaded receptacle;
wherein each fastener bolt is torqued to about 100 in-lbs.

2. The carburetor according to claim 1 wherein each said fastener bolt includes a hex head with a threaded shank depending therefrom, said hex head including a washer for uniform load distribution.

3. The carburetor according to claim 2 wherein said washer is an anti-vibration locking washer positioned between said fastener bolt and said throttle body aperture.

4. The carburetor according to claim 2 wherein each said fastener bolt is 12-24, high strength and plated for corrosion resistance.

5. The carburetor according to claim 2 wherein each said fastener bolt is constructed and arranged for receipt of a safety wire tied between adjoining fastener bolts.

6. The carburetor according to claim 1 wherein spacing between first and second apertures at the front of said carburetor is about 71.44 mm, spacing between second and third apertures at the front right of said carburetor is about 53.74 mm, spacing between third and fourth apertures at the rear right of said carburetor is about 53.77 mm, spacing between fourth and fifth apertures at the rear of said carburetor is about 33.32 mm, spacing between fifth and sixth apertures at the rear left of said carburetor is about 40.25 mm, and spacing between sixth and first apertures at the front left of said carburetor is about 62.40 mm.

7. The carburetor according to claim 1 wherein said second, third and fourth fastener bolts are safety wired together, and said first, fifth, and sixth fastener bolts are safety wired together.

8. A carburetor having a throttle body with an air inlet and a combustible mixture outlet forming a mixing chamber, and a float bowl housing fastened to said throttle body, an improvement comprising:
forming a throttle body with six apertures positioned along a base, wherein spacing between first and second apertures at the front of said carburetor is about 71.44 mm, spacing between second and third apertures at the front right of said carburetor is about 53.74 mm, spacing between third and fourth apertures at the rear right of said carburetor is about 53.77 mm, spacing between fourth and fifth apertures at the rear of said carburetor is about 33.32 mm, spacing between fifth and sixth apertures at the rear left of said carburetor is about 40.25 mm, and spacing between sixth and first apertures at the front left of said carburetor is about 62.40 mm,
constructing a float bowl housing to include six threaded receptacles placed axial alignment with said throttle body apertures;
positioning a gasket between said throttle body and said float bowl housing;
placing a fastener bolt through each said aperture for engaging each said threaded receptacle;
torqueing each fastener bolt to about 100 in-lbs. for securing said throttle body to said float bowl housing wherein said gasket is evenly compressed.

9. The carburetor according to claim 8 wherein each said fastener bolt includes a fastener bolt having a large hex head with a threaded shank depending therefrom, said hex head including a washer formed integral thereto for uniform load distribution.

10. The carburetor according to claim 9 wherein said washer is an anti-vibration locking washer positioned between said fastener bolt and said throttle body aperture.

11. The carburetor according to claim 8 wherein each said fastener bolt is 12-24, high strength, and plated for corrosion resistance.

12. The carburetor according to claim 8 wherein each said fastener bolt is drilled for receipt of a safety wire, wherein three fastener bolts are safety wired together.

13. The carburetor according to claim 1 wherein said second, third and fourth fastener bolts are safety wired together, and said fifth, sixth and first fastener bolts are safety wired together.
